(19) United States
(12) Patent Application Publication
(10) Pub. No.: US 2018/0316230 A1
(43) Pub. Date: Nov. 1, 2018

(54) STATOR ASSEMBLY

(71) Applicant: Hanon Systems, Daejeon (KR)

(72) Inventors: Philipp Benjack, Kerpen (DE); Frank Mau, Aachen (DE); Stephan Heinrichs, Hürtgenwald (DE)

(21) Appl. No.: 15/938,847

(22) Filed: Mar. 28, 2018

(30) Foreign Application Priority Data
Apr. 28, 2017 (DE) 102017109256.0

(51) Int. Cl. H02K 1/14; H02K 1/18; H02K 1/08; H02K 21/16; H02K 3/28; H02K 5/24

(52) U.S. Cl. CPC H02K 1/146; H02K 1/185; H02K 5/24; H02K 21/16; H02K 3/28; H02K 1/08

(57) ABSTRACT

The invention relating to a stator assembly (1) in an electrically multi-phase activated drive motor with a stator (3) comprising several stator teeth (2), wherein the stator teeth (2) comprise a tooth surface (5) directed toward a pivotably supported rotor (4), has as its objective specifying a stator assembly [1] that enables a reduction of the noise and vibrations occurring during operation of a drive motor. This task is resolved thereby that at least one stator tooth (2) for each motor phase of the drive motor is implemented such that on the tooth surface (5) of this stator tooth (2) are disposed at least one first planar-formed surface region (6) and maximally one second surface region (7) comprising a curvature.

The invention relates to a stator assembly in a drive motor electrically activated with several phases. The drive motor comprises a stator with several stator teeth, each stator tooth comprising one stator winding and several stator windings being interconnected to form a motor phase that is connected to one of the several activating phases such that it is electrically conducting and wherein the stator teeth have a tooth surface directed toward a rotor.

Drive motors that are electrically activatable with several phases are utilized in many fields of technology. These motors often comprise a stator with several stator teeth and a rotor pivotably supported in a rotational axis. The surfaces of the stator teeth oriented toward the rotor are spaced apart from the surface of the rotor by a so-called air gap. On the stator teeth one stator winding each is disposed, with this stator winding being connected to one of the three, for example, activating phases according to a defined scheme such that it is electrically conducting. Therewith, several stator windings of several stator teeth form a so-called motor phase which is connected to one of the several phases that activate the motor. The number of the several phases externally activating the drive motor herein agrees with the number of the motor phases formed in the drive motor. Such drive motors which, for example, comprise three activating phases and three motor phases, are also employed, for example, in electric air conditioning compressors in hybrid and electric motor vehicles.

According to prior art, attempts are made to construct the air gap, thus the spacing between the rotor surface and the tooth surfaces of the stator teeth, uniformly and small. Consequently, a rounded tooth surface is formed which is adapted to the rounded course of the rotor surface.

In the implementation of these drive motors it is problematic that harmonic waves of the torque-forming magnetic flux in the air gap between stator and rotor surfaces lead to strong vibrations and therewith to noise excitation in the electric motor.

Such generation of noise and vibrations, which is also known as Noise, Vibration, Harshness, or in combination as NVH, is especially in motor vehicles perceived as highly annoying and objectionable. Vehicle manufacturer and suppliers of components are making efforts to avoid such audible and perceivable oscillations since the perception of such disturbances, especially by the driver of the motor vehicle, affects significantly the overall impression of the product. If the degree of noise and vibrations exceeds a so-called tolerance threshold, it can also lead to complaints and objections by the customer which should certainly be avoided.

JP 002005278268 A discloses a stator-rotor assembly in a drive motor which proposes straightening the surfaces of the stator teeth to decrease the occurring noise and vibrations. However, this solution does not offer sufficient reduction of the noise and vibration formation that current requirements demand.

US 2006 279158 A discloses a permanent magnet motor with a rotor and permanent magnets disposed therein and a stator, wherein an outer circumferential surface of the rotor is opposite to an inner circumferential surface of the stator. It is provided that the outer circumferential surface of the rotor and/or the inner circumferential surface of the stator are varied in their surfaces in a radial direction. Especially variations of both surfaces represent increased expenditures in the fabrication of the permanent magnet motor.

It is the objective of the invention to specify a stator assembly that enables improved reduction of the noises and vibrations occurring during operation of a drive motor.

This task is resolved through a subject matter with the characteristics according to Patent Claim 1 of the independent patent claims. Further developments are specified in the dependent Patent Claims 2 to 10.

It is intended to attain an improvement of the NVH behavior of a multi-phase, electrically activated drive motor, which is utilized for example in an electrical refrigerant compressor, by a change of the geometry of the tooth surface of one or several stator teeth of each motor phase. For this purpose, on at least one stator tooth, that belongs to a motor phase of the electrically activated multiphase drive motor, a change of the tooth surface is carried out such that this tooth surface comprises at least one first planar-formed surface region as well as also maximally a second surface region having a curvature.

In the case of a three-phase activated drive motor, this shaping according to the invention of the tooth surface is carried out on at least three stator teeth, each of which is associated with a different phase. By this association is meant that a first stator tooth is provided with a first stator winding which is electrically connected with the first phase and so on. As is conventional in prior art, a phase can be connected to several windings that are applied on several stator teeth.

It is also provided that a tooth surface of a stator tooth is substantially oriented toward a surface of the rotor of the drive motor.

It is essential that the fraction of the first planarly implemented surface region, which is oriented perpendicularly to a center axis of the stator tooth, is between at least 45% and equal to or less than 80% of the entire directed length (total length) of the stator tooth.

The number of stator teeth shaped according to the invention is developed in relationship to the number of motor phases by means of multiplication of the number of phases by an integer in the range of equal to or greater than one. In the case of a three-phase activated drive motor, accordingly, three stator teeth minimally are implemented with the tooth surface shaped according to the invention. Alternatively, for example six, nine, twelve . . . , etc. stator teeth can also be implemented with the tooth surface shaped according to the invention.

It is provided that the second surface region that shows the curvature is implemented with a concave curvature and this concave curvature has a radius r, with the radius r having its center point in the rotational axis of the stator.

With respect to a center axis of the stator tooth, the surface of the stator tooth can be implemented symmetrically. The second surface region having a curvature is herein disposed in the center of the tooth surface such that it is oriented symmetrically toward the center axis. Furthermore, on both ends of the second surface region having a curvature one first planar formed surface region each is disposed, whereby the overall symmetry of the tooth surface is maintained.

Alternatively, the surface of the stator tooth is implemented nonsymmetrically with respect to the center axis of the stator tooth. In this case it is provided to dispose only one first planar-formed surface region and only one second surface region having a curvature on the tooth surface. The position of the surface regions with respect to one another is herein freely selectable.

It is provided that between a surface of the rotor of the drive motor and the second surface region having a curvature, a uniform gap is developed. These surfaces have a course that is adapted to each other.

It is furthermore provided that the stator teeth, implemented with the tooth surface according to the invention, are disposed at equal spacing along the circumference of the stator. For example, three such stator teeth associated with three different phases are disposed such that they are aligned at an angle of 120 degrees with respect to one another. For example, in the case of six such stator teeth the angle between two adjacent stator teeth is still 60 degrees with two stator teeth being in each instance associated with one of the three phases.

Further details, characteristics and advantages of implementations of the invention are evident in the following description of embodiment examples with reference to the associated drawing. Therein depict:

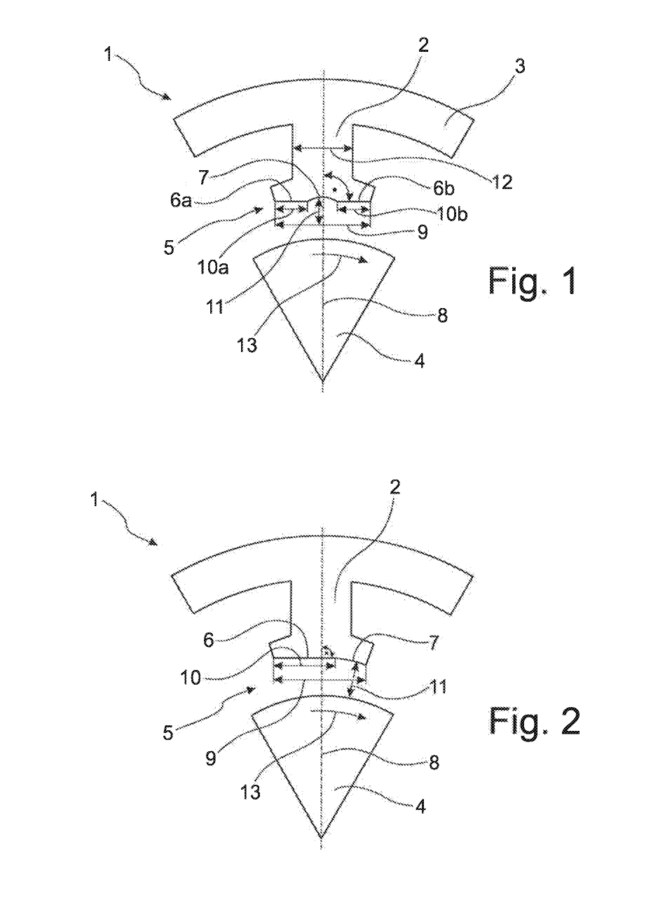

FIG. 1: a first embodiment of a stator tooth according to the invention with two planar-formed surface regions and one surface region comprising a curvature,

FIG. 2: a second embodiment of the invention with a planar-formed surface region and one surface region comprising a curvature,

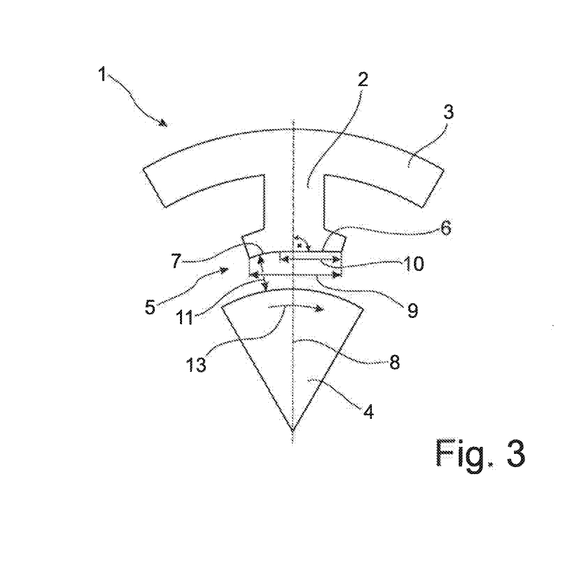

FIG. 3: an alternative embodiment of the invention with a planar-formed surface region and a surface region comprising a curvature.

In FIG. 1 is shown a first embodiment of a stator tooth 2 according to the invention of a stator assembly 1. The stator tooth 2 comprises on its tooth surface 5, which is oriented toward the rotor of the drive motor, two first planar-formed surface regions 6a and 6b as well as a second surface region 7 comprising a curvature.

In FIG. 1 only a sector of the stator 3 of the stator assembly 1 with one stator tooth 2 is depicted, wherein the stator 3 comprises several stator teeth 2 distributed over the circumference of stator 3. The depicted stator tooth 2 is, for example, assigned to a first phase of the drive motor, which means its stator winding, not shown in FIG. 1, is electrically connected with the first phase of the drive motor. This first phase of the drive motor can be connected to further stator windings on further stator teeth 2.

According to the invention it is provided to shape at least one stator tooth 2 of each phase of the drive motor such as is shown in the embodiment examples of FIGS. 1 to 3. Consequently, in a three-phase activated drive motor, for example at least three stator teeth 2, thus one for each phase, comprise the structure according to the invention on the tooth surface 5.

It is also provided that the number of stator teeth 2 shaped according to the invention is an integer multiple of the number of phases of the drive motor. In a three-phase activated drive motor three, six, nine . . . etc. stator teeth 2 can thus he implemented with a tooth surface 5 modified according to the invention.

In FIG. 1 the total length 9 of the tooth surface 5 of stator tooth 2 is depicted which is to extend in the rotational direction 13 of rotor 4, which is only shown as a rotor sector. Also oriented in this extension are the two lengths 10a and 10b of the two first planar-formed surface regions 6a and 6b.

It is of advantage for the ratio of the sum of lengths 10a and 10b of the two first planar-formed surface regions 6a and 6b to the total length 9 to have a value between more than 0.45 and maximally 0.8. This means the sum of lengths 10a plus 10b is at least more than 0.45 times the total length 9 and maximally 0.8 times the total length 9. The total length 9 can also be denoted as the direct length.

Since the tooth surface 5 of a stator tooth 2 referred to the depictions in FIGS. 1 to 3 extends into the depth of the particular Figure, the described dimensioning can also be applied to the surface regions 6a and 6b. The fraction of the first planar-formed surface region 6, which in FIG. 1 is composed of the subregions 6a and 6b, referred to the total tooth surface 5 of stator tooth 2, is consequently in the range of more than 45% to maximally 80%. Potential inaccuracies, brought about by the second surface region 7 formed out with a curvature, can be neglected.

The relationships of the lengths (direct length or total length in the rotational direction 13 to the length of the first planar-formed surface region) to one another can be described as follows:

0.45*direct length<a+b≤0.8*direct length

where a represents the length 10a of surface region 6a, and b the length 10b of surface region 6b.

In FIG. 1 a second surface region 7 comprising a curvature is disposed in the middle between the planar surface region 6a and 6b. The tooth surface 5 in this case is implemented symmetrically with respect to a center axis 8 of the stator tooth 2.

As depicted in FIG. 1, the course of the surface region 7 comprising the curvature can be adapted to the course of the surface of rotor 4. The surface of rotor 4 and of surface region 7 extend at equal spacing with respect to one another. The gap 11 resulting between these surfaces is of equal size in the proximity of the second surface region 7.

The invention provides furthermore that the first planar-formed surface regions 6a and 6b are oriented perpendicularly to the center axis 8 of the stator tooth 2. This is depicted by the symbol for a right angle in FIGS. 1 to 3.

Through the dimensioning described above of the lengths or the surfaces is ensured that a portion of the first planar-formed surface region 6a and/or 6b is already disposed within the width 12 of stator tooth 2 rather than in the broadening of the rotor surface. Herefrom results an improvement in the decrease of the noise formation through the drive motor.

As is conventional in prior art, a stator tooth 2 can be constructed of several planes or layers of a metallic material in a packet comprising several equally stamped-out metal sheets. The tooth surface 5 of stator tooth 2 is implemented in this case by the partial surfaces of the individual layers, which has no effect on the present invention.

In FIG. 2 a second embodiment of the invention is depicted with a first planar-formed surface region 6 and a second surface region 7 comprising a curvature. In the depiction of FIG. 2 the second surface region 7 comprising a curvature is disposed to the right

of the first planar-formed surface region 6.

A further difference from FIG. 1 herein comprises that only a first planar-formed surface region 6 is disposed on the tooth surface 5 of stator tooth 2.

In this embodiment it is also provided that the fraction of the first planar-formed surface region 6 referred to the entire tooth surface 5 of stator tooth 2 is in the range of approximately more than 45% to maximally 80%. The length 10 of the first planar-formed surface region [6] in the rotational direction 13 is consequently in a range between more than 0.45 times and maximally 0.8 times the total length 9 or the direct length, viewed also in the rotational direction 13. Consequently

0.45*total length 9<surface region 6≤0.8*total length 9.

The invention provides that the course of the surface region 7 comprising a curvature is adapted to the course of the surface of rotor 4, as is shown in FIG. 2. The surfaces, surface of rotor 4 and surface region 7, therewith extend parallel to one another or the spacing of the surfaces from one another, for example depicted through gap 11, at any opposing point pair is of equal size.

Provided is also that the first planar-formed surface region 6 is disposed such that it is oriented perpendicularly to the center axis 8 of stator tooth 2.

The relations of the lengths (direct length or total length 9 in the rotational direction 13 to the length of the first planar-formed surface region) to one another can be described, for example, as follows:

0.45*direct length<a≤0.8*direct length

where a represents the length 10 of surface region 6.

In FIG. 3 is depicted an alternative third embodiment of the invention with a first planar-formed surface region 6 and a second surface region 7 comprising a curvature. In contrast to the embodiment of FIG. 2, in the depiction of FIG. 3 the second surface region 7 comprising a curvature is disposed to the left of the first planar-formed surface region 6.

### LIST OF REFERENCE NUMBERS

1 Stator assembly

2 Stator tooth

3 Stator (stator sector)

4 Rotor (rotor sector)

5 Tooth surface

6, 6a, 6b First planar-formed surface region

7 Second surface region comprising a curvature

8 Center axis of stator tooth

9 Total length (direct length) in rotational direction

10, 10a, 10b Length of first planar-formed surface region in the rotational direction

11 Gap

12 Width of stator tooth

13 Rotational direction

1.-10. (canceled)

11. A stator assembly in an electrically multiphase activated drive motor, comprising a stator with several stator teeth, wherein each stator tooth comprises one stator winding and several stator windings are interconnected to form a motor phase that is connected with one of the several activating phases such that it is electrically conductive and wherein the stator teeth comprise a tooth surface directed toward a rotor, wherein at least one stator tooth for each motor phase of the drive motor is implemented such that on the tooth surface of this stator tooth at least one first planar-formed surface region and maximally one second surface region comprising a curvature is disposed.

12. A stator assembly as in claim 11, wherein the fraction of all first planar-formed surface regions of a stator tooth is between more than 45% and less or equal to 80% of the total tooth surface of the stator tooth.

13. A stator assembly as in claim 11, wherein the planar-formed surface region or regions is or are disposed oriented perpendicularly to a center axis of the stator tooth.

14. A stator assembly as in claim 11, wherein the second surface region comprising a curvature with radius r is concavely formed on the tooth surface of stator tooth and disposed between two first planar surface regions.

15. A stator assembly as in claim 14, wherein the tooth surface of stator tooth is formed symmetrically with respect to the center axis of stator tooth.

16. A stator assembly as in claim 11, wherein the second surface region comprising a curvature with radius r is disposed next to a first planar surface region.

17. A stator assembly as in claim 11, wherein the surface region having a radius r is disposed such that its surface is disposed such that it extends at equal distance to a surface formed by a rotor.

18. A stator assembly as in claim 11, wherein the stator teeth of the electrical motor phases of the drive motor that comprise a first and a second surface region are disposed uniformly spaced apart over the circumference of the stator.

19. A stator assembly as in claim 11, wherein the number of stator teeth in each electrical motor phase of the drive motor that have a first and a second surface region is an integer multiple of the number of the activating electrical phases of the drive motor.

20. A stator assembly as in claim 11, wherein the center point of radius r is disposed congruent with the rotational axis of rotor.

21. A stator assembly as in claim 12, wherein the second surface region comprising a curvature with radius r is disposed next to a first planar surface region.

22. A stator assembly as in claim 13, wherein the second surface region comprising a curvature with radius r is disposed next to a first planar surface region.

23. A stator assembly as in claim 12, wherein the number of stator teeth in each electrical motor phase of the drive motor that have a first and a second surface region is an integer multiple of the number of the activating electrical phases of the drive motor.

24. A stator assembly as in claim 13, wherein the number of stator teeth in each electrical motor phase of the drive motor that have a first and a second surface region is an integer multiple of the number of the activating electrical phases of the drive motor.

25. A stator assembly as in claim 14, wherein the number of stator teeth in each electrical motor phase of the drive motor that have a first and a second surface region is an integer multiple of the number of the activating electrical phases of the drive motor.

26. A stator assembly as in claim 15, wherein the number of stator teeth in each electrical motor phase of the drive motor that have a first and a second surface region is an integer multiple of the number of the activating electrical phases of the drive motor.

27. A stator assembly as in claim 16, wherein the surface region having a radius r is disposed such that its surface is disposed such that it extends at equal distance to a surface formed by a rotor.

28. A stator assembly as in claim 11, wherein the surface region having a radius r is disposed such that its surface is disposed such that it extends at equal distance to a surface formed by a rotor.

29. A stator assembly as in claim 12, wherein the stator teeth of the electrical motor phases of the drive motor that comprise a first and a second surface region are disposed uniformly spaced apart over the circumference of the stator.

30. A stator assembly as in claim 13, wherein the stator teeth of the electrical motor phases of the drive motor that comprise a first and a second surface region are disposed uniformly spaced apart over the circumference of the stator.
